(19) United States
(12) Patent Application Publication
(10) Pub. No.: US 2011/0289210 A1
(43) Pub. Date: Nov. 24, 2011

(54) CONNECTING PORTS OF ONE OR MORE ELECTRONIC DEVICES TO DIFFERENT SUBSETS OF NETWORKS BASED ON DIFFERENT OPERATING MODES

(76) Inventors: Keith L. Kelley, Houston, TX (US); Charles L. Hudson, Round Rock, TX (US); John M. Hemphill, Spring, TX (US)

(21) Appl. No.: 13/146,934

(22) PCT Filed: Jan. 29, 2009
(86) PCT No.: PCT/US2009/032369

§ 371 Date: Jul. 29, 2011

(51) Int. Cl. G06F 15/173

(52) U.S. Cl. 709/224; 709/223

(57) ABSTRACT

A connection apparatus includes at least one module to connect network ports of one or more electronic devices to network ports that are connected to respective networks, and a manager to create at least one profile for a particular one of the one or more electronic devices. The at least one profile specifies that the particular electronic device is to be connected to different subsets of the networks for corresponding different modes of operation of the particular electronic device.

### BACKGROUND

Enterprises such as companies, educational organizations, government agencies, and so forth, are increasingly using concentrated arrangements of equipment, which can be in the form of equipment racks containing multiple servers, storage devices, communications devices, or other types of electronic devices. A challenge associated with use of an equipment rack is that the equipment rack may include a relatively large number of electronic devices that have to be connected to external networks, including local area networks (LANs), wide area networks (WANs), storage area networks (SANs), and so forth. Connecting a relatively large number of electronic devices to external networks may involve the use of a relatively large number of cables, which can be unwieldy and can lead to increased faults and points of failure.

To reduce the amount of cables used to connect electronic devices in an equipment rack to external networks, one or more modules that provide an abstraction layer can be connected between the equipment rack and the external networks. Examples of such modules include virtual connect modules provided by the Hewlett-Packard Company.

A virtual connect module can be configured by an administrator to connect ports of electronic devices in the equipment rack with selected networks, which can include LANs, WANs, SANs, and/or other types of networks. However, once the connections between ports of a particular electronic device and a set of external networks is configured, no convenient mechanism has been provided to change the connection of the ports of the particular electronic device to the external networks.

### BRIEF DESCRIPTION OF THE DRAWINGS

Some embodiments of the invention are described, by way of example, with respect to the following figures:

FIG. 1 is a schematic diagram of an exemplary arrangement that includes a connection mechanism that allows network ports of electronic devices to be connected to different subsets of networks depending upon the operating modes of the electronic devices, in accordance with some embodiments;

FIG. 2 illustrates a mode-based profile used for connecting network ports of an electronic device to networks, according to an embodiment; and

FIG. 3 is a flow diagram of a process of dynamically changing network connections of an electronic device based upon the operating mode of the network device, in accordance with an embodiment.

### DETAILED DESCRIPTION

In accordance with some embodiments of the invention, a connection mechanism is provided to dynamically change connections of network ports of an electronic device to networks, depending on the operating mode of the electronic device. An “electronic device” can be a computer, a storage device, a communications device, or any other type of device that has network ports for connection to respective one or more networks. The networks to which the network ports of the electronic device can be connected include local area networks (LANs), wide area networks (WANs), storage area networks (SANs), and/or other types of networks.

A “network port” of an electronic device refers to an interface (implemented with hardware and/or software) of the electronic device that is able to communicate with a respective network if properly connected. Connections between the network ports of an electronic device and networks can be specified by one or more mode-based profiles that are applicable to the electronic device. The one or more mode-based profiles can specify that the network ports of the electronic device are to be connected to a first subset of networks for a first operating mode of the electronic device, and to a second, different subset of networks for a second, different operating mode of the electronic device.

In one specific example, a first operating mode of the electronic device is when the electronic device is booting or initializing during power up or reset. During boot or initialization, the electronic device may have to access a remotely stored boot image that is located in a first network, where the boot image is used to boot the electronic device. After the electronic device has successfully booted, the electronic device may access a second, different network during normal operation of the electronic device. Thus, the two operating modes in the example above include a boot mode and a non-boot (or normal) mode. Other examples of operating modes are contemplated in other implementations.

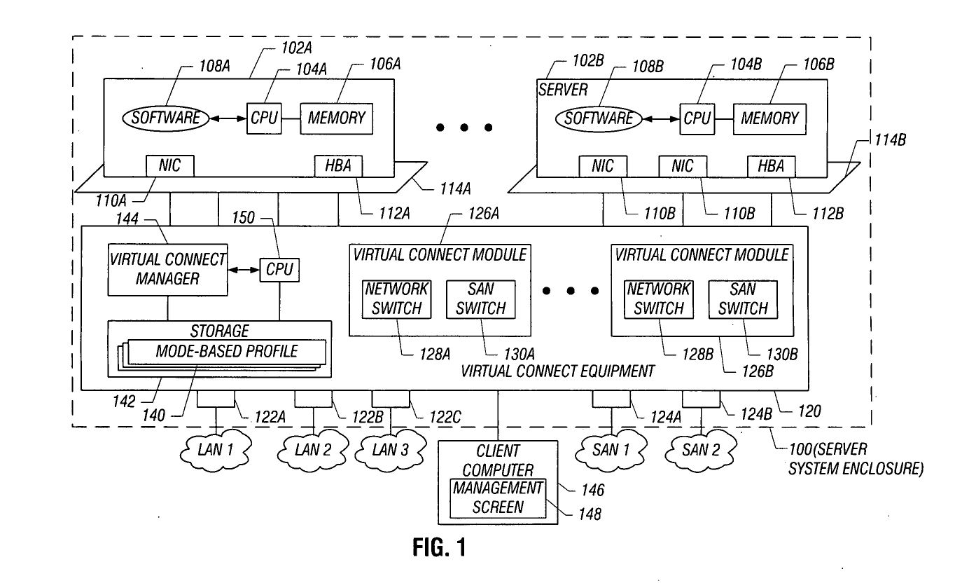

FIG. 1 illustrates an exemplary arrangement that includes a server system enclosure 100 containing multiple server computers 102A, 102B. In the ensuing discussion, reference is made to server computers (or more simply “servers”), which are computers having resources (e.g., software applications, database applications, etc.) that are accessible by remotely located client computers. The server computers can be blade servers or non-blade servers. Although the following discussion refers to racks containing servers (e.g., blade servers), it is noted that techniques according to some embodiments are applicable to other types of electronic devices, such as other types of computers, storage devices, communications devices, and so forth.

The server system enclosure 100 can be in the form of a rack having multiple bays to receive respective servers. The server 102A is received in a first bay 114A of the server system enclosure 100, while the server 102B is received in a second bay 114B of the server system enclosure 100. The bays of the server system enclosure 100 can be defined by slots or other types of receptacles for receiving respective servers. Although just two servers are depicted in FIG. 1, it is noted that in a different implementation, just one server can be provided, or more than two servers can be provided. The dashed box in FIG. 1 represents an external housing of the server system enclosure 100 that defines an inner chamber in which the servers 102A, 102B are mounted.

The server 102A includes one or more central processing units (CPUs) 104A that are connected to memory 106A. Software 108A is executable on the CPU(s) 104A. The server 102A also includes various network ports. In the example of FIG. 1, the server 102A includes a network interface controller (NIC) 110A and a host bus adapter 112A. The NIC 110A is used to allow the server 102A to communicate over one of LANs 1, 2, and 3 in the example of FIG. 1. The NIC 110A constitutes a first type of network port.

Another type of network port is the host bus adapter 112A, which is used to access certain types of networks, such as a storage area network (SAN), which can be either SAN 1 or SAN 2 depicted in FIG. 1. SAN 1 or SAN 2 can be a Fibre Channel network, a SCSI (Small Computer System Interface) network, or other type of storage network, such as a Fibre Channel over Ethernet (FCoE) storage network, a Serial-Attached SCSI (SAS) storage network, and so forth. Although just one NIC 110A and one host bus adapter 112A are depicted, it is noted that in other implementations, the server 102A can include more than one NIC or more than one host bus adapter to connect to corresponding networks.

The server 102B similarly includes one or more CPUs 104B connected to memory 106B. Software 108B is executable on the CPU(s) 104B. In the example of FIG. 1, the server 102B includes NICs 110B and a host bus adapter 112B.

The server system enclosure 100 also includes virtual connect equipment 120, which provides a mechanism to selectively connect network ports of the servers 102A, 102B (including NICs 110A, 110B and host bus adapters 112A, 112B) to external network ports 122A, 122B, and 122C and network ports 124A, 124B. The external network ports 122A-122C are connected to respective local area networks (LAN 1, LAN 2, and LAN 3), whereas the external network ports 124A, 124B are connected to respective storage networks (SAN 1 and SAN 2).

The virtual connect equipment 120 provides an abstraction layer between the servers 102A, 102B and the external networks (LANs 1-3 and SANs 1-2). The virtual connect equipment 120 includes one or more virtual connect modules 126 (126A, 126B) depicted to configurably connect the network ports of the servers 102A, 102B to the external network ports 122A-122C and 124A-124B. Each virtual connect module includes a network switch 128A or 128B and a SAN switch 130A or 130B. The network switch 128A or 128B is used to connect NICs 110A, 110B to respective LANs 1-3, whereas the SAN switch 130A-130B is used to configurably connect the host bus adapters 112A, 112B to SAN 1-2.

The specific connections between the network ports of a given server 102A or 102B and a corresponding subset of the external networks (where a “subset” refers to either all or less than all of the available networks to which the servers can connect) are specified by a corresponding mode-based profile 140 that is stored in a storage 142 in the virtual connect equipment 120. The mode-based profile 140 can be defined for a particular bay (114A or 114B) of the server system enclosure 100, such that any server connected to that specific bay will be connected to the external networks according to the settings of the profile 140. Multiple mode-based profiles 140 can be stored in the storage 142 for multiple corresponding bays of the server system enclosure 100. In a different implementation, instead of associating a profile 140 with a specific bay, the profile can be associated with a specific server.

A mode-based profile 140 can define different network connections for different operating modes of the corresponding server. For example, the mode-based profile 140 can specify that the NIC 110A of server 102A is to be connected to LAN 1 for a first mode of operation, and to be connected to LAN 2 for a second mode of operation. Similarly, the mode-based profile 140 can specify that the host bus adapter 112A of the server 102A is to be connected to SAN 1 for a first mode of operation, and to SAN 2 for a second mode of operation. Another mode-based profile 140 can specify configurable connections between the network ports of the server 102B and the networks LAN 1-3 and SAN 1-2 according to different operating modes.

Note that not every network port has to be connected to a corresponding network in every mode. For example, mode 1 may specify that just one network connection be made (such as a NIC to a LAN or a host bus adapter to a SAN), while mode 2 may specify that several network connections be made between network ports and respective networks. Note also that there may be modes in which no network and/or storage connection is provided.

In the discussion above, it is assumed that a mode-based profile 140 can specify multiple modes and respective different network connections according to the different modes. In a different implementation, one profile per mode per bay or server can be specified, where each such profile specifies just one mode and the corresponding network connections.

The content of the mode-based profile 140 can be generated by a virtual connect manager 144 in the virtual connect equipment 120. An administrator can remotely access the virtual connect manager 144 using a client computer 146. The virtual connect manager 144 can provide an application programming interface (API) or web-based interface to allow the client computer 146 to present a management screen 148 that is displayed in a display device of the client computer 146. Using the management screen 148, the administrator can specify the number of modes to be included in a profile 140, and the network connections for each mode.

The virtual connect manager 144 can be a software module executable on one or more CPUs 150 of the virtual connect equipment 120. Although depicted as being external to the virtual connect modules 126A, 126B, it is noted that the virtual connect manager 144, CPU(s) 150, and/or storage 142 can be incorporated in one or more of the virtual connect modules 126A, 126B.

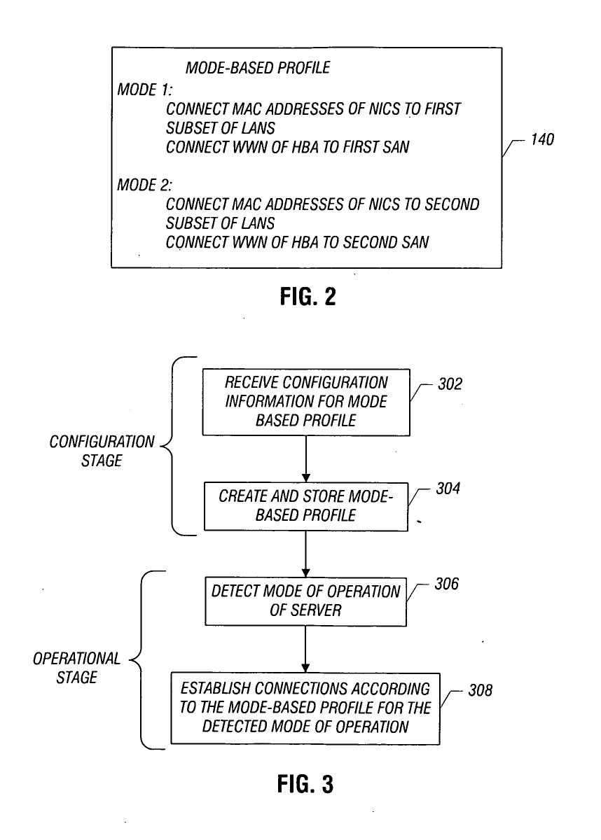

An exemplary mode-based profile 140 is depicted in FIG. 2, which specifies different network connections for different modes (mode 1 and mode 2). In mode 1, the MAC (media access control) addresses of respective NICs of a particular server are specified as being connected to a first subset of LANs, while a worldwide name (WWN) of a host bus adapter is specified as being connected to a first SAN. In mode 2, the mode-based profile 140 specifies that the MAC addresses of the NICs are connected to a second subset of LANs, while the WWN of the host bus adapter is connected to a second SAN.

In an alternative implementation, the mode-based profile can specify that the host bus adapter is connected to the same SAN for the different modes (such that the host bus adapter is connected to the same SAN in either mode 1 or mode 2). Alternatively, the mode-based profile can specify that the host bus adapters are connected to different SANs in different modes, but to the same LAN in the different modes.

FIG. 3 illustrates a procedure according to an embodiment of the invention. The procedure of FIG. 3 includes a configuration stage and an operational stage. In the configuration stage, the virtual connect manager 144 receives (at 302) configuration information for a mode-based profile that is defined for a particular bay or server. The configuration information can be received from the client computer 146, or alternatively, the configuration information can be predefined and loaded in the virtual connect equipment 120.

As part of the configuration stage, the virtual connect manager 144 creates (or updates) and stores (at 304) the mode-based profile based on the received configuration information.

During the operational stage, the virtual connect modules 126A, 126B detect (at 306) the mode of operation of a particular server. Based on the detected mode of operation, the virtual connect module 126A and/or 126B establishes (at 308) connections according to the corresponding mode-based profile 140 that is retrieved from the storage 140 shown in FIG. 1. Thus, for example, during a boot mode, the virtual connect module 126A and/or 126B can cause the NIC 110A of the server 102A to connect to LAN 1 to retrieve a boot image stored on a device in LAN 1. The boot image is used to boot the server 102A and to load the appropriate software into the server 102A. Next, after boot, during the normal operating mode, the virtual connect module 126A and/or 126B can cause the NIC 110A to connect to LAN 3 to access devices on LAN 3, such as storage devices, web servers, and so forth.

Using mechanisms according to some embodiments, changing connections for different modes is simplified, repeatable, and reliable. Dynamically changing connections according to different modes can be performed in a secure manner, since the profiles 140 can be made to be updateable by users with a higher security privilege.

Instructions of software described above (including the virtual connect manager 144 of FIG. 1) are loaded for execution on a processor (such as one or more CPUs 150 in FIG. 1). The processor includes microprocessors, microcontrollers, processor modules or subsystems (including one or more microprocessors or microcontrollers), or other control or computing devices. A “processor” can refer to a single component or to plural components (e.g., one CPU or multiple CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A connection apparatus, comprising:
at least one module to connect network ports of one or more electronic devices to network ports that are connected to respective networks; and
a manager to create at least one profile for a particular one of the one or more electronic devices, wherein the at least one profile specifies that the particular electronic device is to be connected to different subsets of the networks for corresponding different modes of operation of the particular electronic device.

2. The connection apparatus of claim 1, wherein the at least one module is to:
detect a mode of operation of the particular electronic device; and
connect network ports of the particular electronic device to one of the different subsets of the networks in response to the detected mode of operation, based on accessing the at least one profile.

3. The connection apparatus of claim 2, wherein the at least one module is to:
detect that the particular electronic device is in a first mode of operation;
connect the network ports of the particular electronic device to a first one of the different subsets of the networks for the first mode of operation;
detect that the particular electronic device is in a second mode of operation;
connect the network ports of the particular electronic device to a second one of the different subsets of the networks for the first mode of operation.

4. The connection apparatus of claim 1, wherein the networks comprise plural local area networks and plural storage networks, wherein each of the electronic devices includes at least one first network port for connection to a respective one or more of the local area networks, and wherein each of the electronic devices includes at least one second network port for connection to a respective one or more of the storage networks.

5. The connection apparatus of claim 4, wherein the at least one profile specifies that a media access control (MAC) address of the first network port of the particular electronic device is to be connected to different local area networks for the different modes of operation.

6. The connection apparatus of claim 4, wherein the at least one profile specifies that a world wide name of the second network port of the particular electronic device is to be connected to different storage networks for the different modes of operation.

7. The connection apparatus of claim 1, wherein the manager is to further cause a management screen to be displayed to allow a user to create the at least one profile.

8. The connection apparatus of claim 1, wherein the at least one module provides an abstraction layer to flexibly connect network ports of the electronic devices to respective networks.

9. The connection apparatus of claim 8, wherein the at least one module comprises a local area network switch and a storage network switch.

10. The connection apparatus of claim 1, wherein the at least one module is to connect the network ports of the electronic devices mounted in an equipment enclosure to the networks.

11. A method of flexibly connecting electronic devices to networks, comprising:
connecting, with connection equipment, network ports of the electronic devices to the networks;
storing, in the connection equipment, at least one profile that specifies that the network ports of a particular one of the electronic devices are to be connected to different subsets of the networks for different operating modes of the particular electronic device;
detecting an operating mode of the particular electronic device; and
connecting the network ports of the particular electronic device to one of the different subsets of the networks in response to the detected mode of operation, based on accessing the at least one profile.

12. The method of claim 11, wherein connecting the network ports of the particular electronic device to one of the different subsets of the networks comprises connecting at least one first network port of the particular electronic device to respective one or more local area networks, and connecting at least one second network port of the particular electronic device to respective one or more storage networks.

13. The method of claim 11, further comprising:
storing, in the connection equipment, at least a second profile that specifies that network ports of a second one of the electronic devices are to be connected to different subsets of the networks for different operating modes of the second electronic device.

14. The method of claim 11, further comprising:
receiving, by the connection equipment, configuration data to update the at least one profile.

15. An article comprising at least one computer-readable storage medium containing instructions that when executed cause connection equipment to:
receive information relating to connections of network ports of an electronic device to networks, wherein the connection equipment includes at least one module to connect the network ports of the electronic device to the networks; and
create at least one profile in response to the received information, wherein the at least one profile specifies that the network ports of the electronic device are to be connected by the connection equipment to different subsets of the networks for different operating modes of the electronic device.
